(19) United States
(12) Patent Application Publication
(10) Pub. No.: US 2004/0154227 A1
(43) Pub. Date: Aug. 12, 2004

(54) Curved glass support structure and wind regulator

(76) Inventor: Tatsuo Yoshimura, Takarazuka-shi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/471,784

(22) PCT Filed: Mar. 19, 2002
(86) PCT No.: PCT/JP02/02630

(30) Foreign Application Priority Data
Mar. 19, 2001 (JP) 2001-078843
Nov. 7, 2001 (JP) 2001-342032

(51) Int. Cl. E05F 11/48

(52) U.S. Cl. 49/352

(57) ABSTRACT

A supporting structure for glass comprises a carrier plate 14 attached to a curved glass 11 elastically guided at a side edge by a glass run 22, and cables 16a and 16b stretched in parallel to the glass run 22 and engaged with the carrier plate 14, and a guide plate 37 sliding in the glass run 22 is disposed to the carrier plate 14. The guide plate 37 is of synthetic resin, has the same thickness as the glass 11 and is increasingly thinner toward below.

### TECHNICAL FIELD OF TLIE INVENTION

The present invention relates to curved glass support structure in a window regulator of an automobile, and a window regulator using the same.

### BACKGROUND ART

Shown in FIG. 19 is a conventional window regulator 100 for driving a window glass (hereinafter referred to simply as “a glass”) of an automobile, together with a structure 101 guiding the glass. The window regulator 100 comprises vertically extending guide rails 102 disposed in front and rear respectively, carrier plates 104 guided by the guide rails in free sliding emotion and attached to the bottom edge of a glass 103, a cable 10G stretched approximately in the shape of 8 by pulleys 105 engaged with the carrier plates at the top and the lower edges of the respective guide rails 102, and a cable drive mechanism 107 for driving the cable to reciprocate circulate. The cable 106 is guided by a conduit 108 for free slide motion.

The front and the rear edges of the glass 103 are guided for free slide motion by glass run guides 109 in a horseshoe shape and with rigidity and glass runs 110 with flexibility housed in the glass run guides 109, as shown in FIG. 20a. As shown in FIG. 20b, said glass 103 is curved in the vertical direction so as to outwardly protrude, and the glass run guides 109 and the guide rails 102 are also curved in accordance with the curved shapes of the glass 103. For this reason, the trajectory of the glass 103 corresponds to that of the carrier plates 104. Further, since the carrier plates 104 are supported by the guide rails 102, the postures of the carrier plates, in particular the positions around the axes in the vertical direction, remain constant to be stable. This makes assembling easy. In other words, the window regulator 100 may be attached to a door panel in advance and the glass 103 may be inserted into the glass runs 110 and moved down, so that the lower edge portion of the glass 103 and the carrier plates 104 would fit together naturally.

On the other hand, already proposed are techniques to absorb a difference between the curved trajectory of the glass 103 and the linear trajectories of the carrier plates 104, by disposing the linearly shaped guide rail 102 and the carrier plate 104 guided for free slide motion by the guide rail 102 and stretching the carrier plate 104 long from side to side for flexibility, as shown in FIG. 21 (Japanese Unexamined Patent Publication No. 1996-199901).

The conventional window regulator 100 shown in FIG. 19 has a so-called double guide structure, where the guide rails 102 firmly guide the glass 103 and lip portions (denoted at 110a in FIG. 20a) of the glass run 110 flexibly guide the glass 103. Noting this, the recent years have seen a proposal that, omitting the front guide rail, the glass run guide 109 and the glass run 110 on the front side guide the glass 103, and the carrier plates 104 are fixed to the glass 103, so that indirect guiding is achieved (see FIG. 22a). Both the front and the rear guides may be omitted. In such case, the pulleys (denoted at 105 in FIG. 19) for changing the direction of the cable 106 may be attached to the glass run guide 109 or a door panel.

However, omission of the guide rails leads to a problem that it is difficult to join the carrier plates and the glass together during assembling. In short, as shown in FIG. 22b, in a condition that the carrier plates 104 and the glass 103 are not joined to each other, the cable 106 is pulled straight, and therefore, the positions of the carrier plates 104 and the position of the glass 103 deviate from each other in the direction of the width of the automobile. The deviation A in the width direction is about 10 to 20 mm, for instance. While slanted guides 112 may be formed at the upper edges of the carrier plates 104 to absorb the deviation, since the positions of the carrier plates 104 around the cable 106 do not become constant, a deviation B is created in the rotative direction as shown in FIG. 22c. For this reason, while holding the glass in one hand, an operator must correct the deviation B in angle of the carrier plates 104 with the other hand and correct the deviation A in the vehicle width direction against the tensile force of the cable 106. This is an extremely difficult operation in reality.

Further, as shown in FIG. 23, although holding structures 114 for guiding the carrier plates 104 may be disposed to the glass run guide 109 as one unit, this makes the structure of the glass run guide 109 complex and increases costs. In addition, since the guide function of the holding structures 114 overlaps the guide function of the glass 103 and the glass run 110, the workability may deteriorate. Unlike in the window regulator shown in FIG. 21, such carrier plates 104 having a small right-and-left size can not be flexible.

A technical task of the present invention is to provide a supporting structure for glass to reduce a difference in trajectory between a glass and a carrier plate in a window regulator using curved glasses even without a guide rail, and therefore, to make assembling of the window regulator easy. Further, a second technical task of the present invention is to provide an easily attachable window regulator with one or both of guide rails omitted.

### DISCLOSURE OF THE INVENTION

A curved glass support structure, comprising: a carrier plate attached to the lower edge (bottom) of the curved glass elastically guided at a side edge by a glass run; a cable stretched in parallel to the glass run and engaged with the carrier plate; and an engagement portion engaging with the carrier plate during attachment of the glass to the carrier plate to thereby stabilize the posture of the carrier plate; wherein a guide plate sliding inside the glass run is disposed to the carrier plate, and the glass run serves as the engagement portion. The “engagement portion” herein referred to includes abutting and sliding.

In this case, it is preferable that the guide plate has substantially the same thickness as that of the glass. Further, it is preferable that the guide plate is formed of synthetic resin.

A curved glass support structure according to a second aspect of the present invention is characterized by comprising a carrier plate attached to the lower egde of the curved glass elastically guided at a side edge by a glass run; a cable stretched in parallel to the glass run and engaged with the carrier plate; and an engagement portion engaging with the carrier plate during attachment of the glass to the carrier plate to thereby stabilize the posture of the carrier plate; wherein the engagement portion is placed below the trajectory of an ascending and descending operation of the carrier plate.

A window regulator for curved glass according to the present invention is characterized by comprising: a first carrier plate and a second carrier plate attached to the lower edge of a curved glass elastically guided at the both side edges by glass runs; a cable engaged with the both carrier plates and stretched in parallel to the glass runs disposed on the front and the rear respectively; a cable drive mechanism for driving the cable to thereby drive the glass through the carrier plates; and an engagement portion engaging with the carrier plates during attachment of the first carrier plate and/or the second carrier plate to the glass to thereby stabilize the postures of the carrier plates; wherein a guide plate sliding inside the glass run is disposed to the first carrier plate or the second carrier plate, and the glass run serves as the engagement portion.

A window regulator for curved glass according to a second aspect of the present invention is characterized by comprising: a first carrier plate and a second carrier plate attached to the lower edge of a curved glass elastically guided at the both side edges by glass runs; a cable engaged with the both carrier plates and stretched in parallel to the glass runs disposed on the front and the rear respectively; a cable drive mechanism for driving the cable to thereby drive the glass through the carrier plates; and an engagement portion engaging with the carrier plates during attachment of the first carrier plate and/or the second carrier plate to the glass to thereby stabilize the postures of the carrier plates; wherein guide projections extending in parallel to the glass runs are formed integrally in all inner panels that the guide projections slide in contact with the carrier plates to thereby stabilize the postures of the carrier plates, and the guide projections are the engagement portions.

A window regulator for curved glass according to a third aspect of the present invention is characterized by comprising: a carrier plate attached to the lower edge of the curved glass elastically guided at the both side edges by glass runs; a cable engaged with the carrier plate and stretched in parallel to the glass runs disposed on the front and the rear respectively; a guide member attached to a panel, for the purpose of changing the direction of the cable; a cable drive mechanism attached to the panel for driving the cable to thereby drive the glass through the carrier plate; and an engagement portion attached to the panel for engaging with the carrier plate during attachment of the carrier plate to the glass to thereby stabilize the posture of the carrier plate.

A window regulator for curved glass according to a forth aspect of the present invention is characterized by comprising: a carrier plate attached to the lower edge of the curved glass elastically guided at the both side edges by glass runs; a cable engaged with the carrier plate and stretched in parallel to the glass runs disposed on the front and the rear respectively; a guide member attached to a panel, for the purpose of changing the direction of the cable; a cable drive mechanism attached to the panel for driving the cable to thereby drive the glass through the carrier plate; and all engagement portion engaging with the carrier plate during attachment of the carrier plate to the glass to thereby stabilize the posture of the carrier plate; wherein the engagement portion is disposed to the upper edge of the cable drive mechanism.

A window regulator for curved glass according to a fifth aspect of the present invention is characterized by comprising: a carrier plate attached to the lower edge of the curved glass elastically guided at the both side edges by glass runs; a cable engaged with the carrier plate and stretched in parallel to the glass runs disposed on the front and the rear respectively; a guide member attached to a panel, for the purpose of changing the direction of the cable; a cable drive mechanism attached to the panel for driving the cable to thereby drive the glass through the carrier plate; and an engagement portion engaging with the carrier plate during attachment of the carrier plate to the glass to thereby stabilize the posture of the carrier plate; wherein the engagement portion is a tube surrounding the cable on the returning side, disposed between the guide member and the cable drive mechanism, and a fitting portion fit around the tube to be freely attached and detached is disposed to the carrier plate.

A window regulator for curved glass according to a sixth aspect, of the present invention is characterized by comprising; a carrier plate attached to the lower edge of the curved glass elastically guided at the both side edges by glass runs; a cable engaged with the carrier plate and stretched in parallel to the glass runs disposed on the front and the rear respectively; a guide member attached to a panel, for the purpose of changing the direction of the cable; a cable drive mechanism attached to the panel for driving the cable to thereby drive the glass through the carrier plate; and an engagement portion engaging with the carrier plate during attachment of the carrier plate to the glass to thereby stabilize the posture of the carrier plate; wherein the engagement portion is placed below the passage of an ascending and descending operation of the carrier plate.

In the supporting structure for the curved glass according to the present invention, since the engagement portion is disposed to stabilize the posture of the carrier plate during attachment of the carrier plate to the glass, the carrier plate, even when not attached to the glass, never freely rotates about the cable. Further, the position of the carrier plate about the cable in the rotative direction becomes generally constant owing to engagement of the carrier plate and the engagement portion. Hence, even if an operator does not strictly position the carrier plate in particular, the operator can attach the carrier plate to the glass.

By disposing the guide plate sliding inside the glass run to the carrier plate to allow the glass run to serve as the engagement portion, the guide plate is inserted into the glass run before attachment of the glass and the posture of the carrier plate becomes stable in that condition. This permits easy attachment of the glass. In addition, even without attachment of the glass, the carrier plate remains approximately on the trajectory of the glass. Hence, the carrier plate does not obstruct ascending and descending of the glass. Where the guide rail is disposed, a double guide structure is created at the single same position after the carrier plate and the glass are attached to each other. Since the glass run is flexible, the guiding of the guide plate by the glass run is flexible.

Therefore, there is almost no problem of “skew caused by double guide.” This eliminates the necessity of detaching the guide plate after attachment but allows the guide plate to remain not removed.

Where the guide plate has substantially the same thickness as that of the glass, there is less possibility that the glass run will be excessively worn out and it is possible to more precisely align the positions of the carrier plate and the glass. In other words, there is a problem that space is created in the direction of the width of a vehicle if the guide plate is formed thinner than the glass, and the guide plate gets worn out if the guide plate is formed thicker than the glass. If the thickness is made the same, however, these problems are solved. Further, where the guide plate is formed of synthetic resin, invasion against the glass run of rubber becomes less intense.

According to the second aspect of the supporting structure for curved glass, the engagement portion is placed below the trajectory of an ascending and descending operation of the carrier plate, so the engagement portion engages with the carrier plate when the carrier plate is not fixed to the glass, and does not interfere with the carrier plate when the carrier plate is fixed to the glass during the ascending and descending operation. Therefore the carrier plate is moved to the position for attachment of the glass to be engaged with the engagement portion in particular posture. This stabilizes the posture of the carrier plate and makes attachment of the glass easy. After the attachment, since the carrier plate moves within the range of normal ascending and descending, there is no possibility that the carrier plate will interfere with the engagement portion.

Since the window regulator according to the present invention comprises the engagement portion stabilizing the posture of the carrier plate by engaging with the carrier plate during attachment of the carrier plate to the glass, despite the curvature of the glass, it is easy to attach the glass to the carrier plate. Further, where the guide plate is disposed to the carrier plate to allow the glass run to serve as the engagement portion in this window regulator, the supporting structure described above may be used for one side edge of the glass and a supporting structure similar to conventional ones realized by a guide rail and a carrier plate may be used at a position somewhat away from the other side edge of the glass. This can enjoy an advantage owing to the use of the guide rail, i.e., an advantage that the glass is reliably guided and it is easy to handle the window regulator as one unit, as well as an advantage of reducing the number of components used and costs owing to omission of one guide rail. In addition, despite omission of one guide rail, this ensures all of the effects of the supporting structure described above such as the easiness of attachment of the carrier plate to the glass.

In the window regulator according to the second aspect of the present invention, since the guide projection formed in an inner panel serves as the engagement portion, the carrier plate slides in contact with the guide the posture of the carrier plate is stable even despite omission of the guide rail. Hence, it is possible to reduce a cost of disposing the guide rail, while maintaining the easiness of attachment of the carrier plate to the glass.

In the window regulator according to the second aspect of the present invention, since the cable drive mechanism realizes the function as a guide member on one side, only one guide member such as a pulley is needed. This window regulator also uses the engagement portion to stabilize the posture of the carrier plate, and therefore, it is easy to attach the carrier plate to the glass. Where the engagement portion is disposed to the upper edge of the cable drive mechanism, it is possible to reduce the number of components and hence production costs. Meanwhile, where the tube disposed between the guide member and the cable drive mechanism forms the engagement portion, it is possible to further stabilize the posture of the carrier plate. In addition, since the guide member and the cable drive mechanism before attached to the inner panel can be integrated by the tube into one unit, handling during transfer will be easy

### BRIEF DESCRIPTION OF THE DRAWINGS

FIG. 1 is a perspective view showing a first preferred embodiment of a supporting structure according to the present invention;

FIG. 2 is an overall front view showing a preferred embodiment of a window regulator comprising the supporting structure;

FIGS. 3a and 3b are a side view and a front view, respectively, of a front guide structure of the window regulator;

FIG. 4 is an enlarged view of a portion C in FIG. 3a;

FIGS. 5a, 5b and 5c are a front view, a side view and a plan cross sectional view, respectively, showing the function of the supporting structure in FIG. 1;

FIG. 6 is a front view showing a rear guide structure of the window regulator in FIG. 2;

FIGS. 7a, 7b and 7c are a front view, a side view and a plan view, respectively, of an area around a carrier plate in FIG. 6;

FIGS. 8a and 8b are a partial cross sectional side view and a front view, respectively, showing other preferred embodiment of the supporting structure according to the present invention;

FIG. 9 is a front view showing another preferred embodiment of a window regulator comprising the supporting structure according to the present invention;

FIG. 10 is a side view of the supporting structure in FIG. 9;

FIG. 11a is a plan view showing the function of the supporting structure in FIG. 10 while FIG. 11b is a plan view showing the function of yet another embodiment of the supporting structure according to the present invention;

FIG. 12 is a front view showing yet another preferred embodiment of the window regulator according to the present invention;

FIG. 13 is a front view showing still other preferred embodiment of the window regulator according to the present invention;

FIG. 14 is a perspective view of the window regulator in FIG. 13;

FIGS. 15a and 15b are all essential enlarged back view and an essential enlarged side view, respectively, showing an area around a pulley and a carrier plate in the window regulator in FIG. 13;

FIG. 16 is an essential enlarged side view showing a cable drive mechanism in the window regulator in FIG. 13;

FIGS. 17a and 17b are an essential enlarged back view and an essential enlarged plane view, respectively, showing the cable drive mechanism in the window regulator of FIG. 13;

FIGS. 18a and 18b are a schematic perspective view and a schematic side view, respectively, showing other preferred embodiment of the window regulator according to the present invention;

FIG. 19 is a front view showing an example of a conventional window regulator;

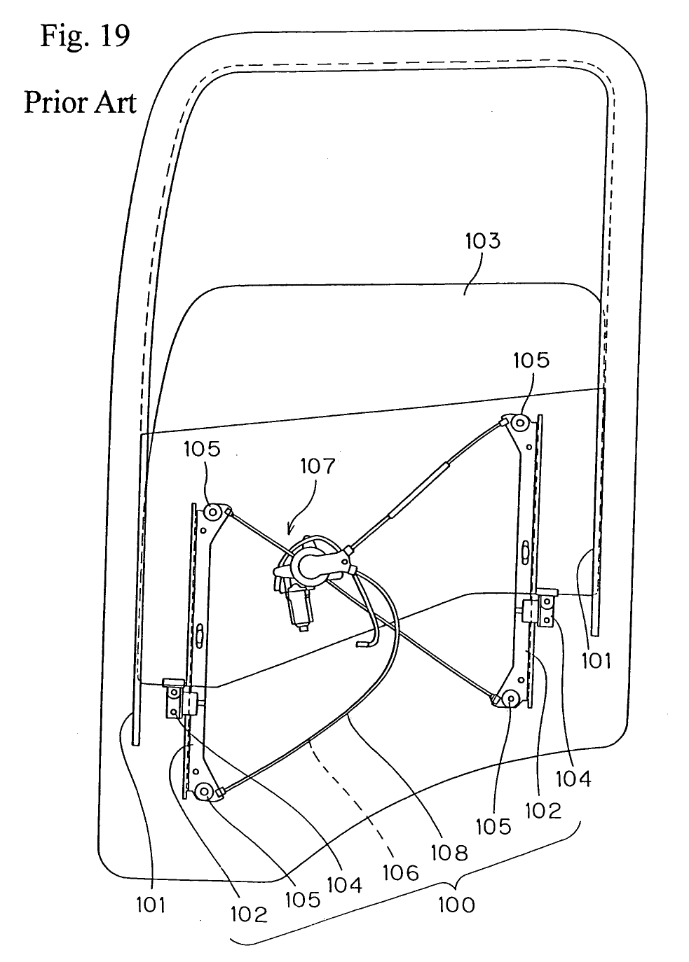

FIG. 20a is a cross sectional view showing an example of a conventional glass run and glass run guide, while FIG. 20b is a side view of the window regulator in FIG. 19;

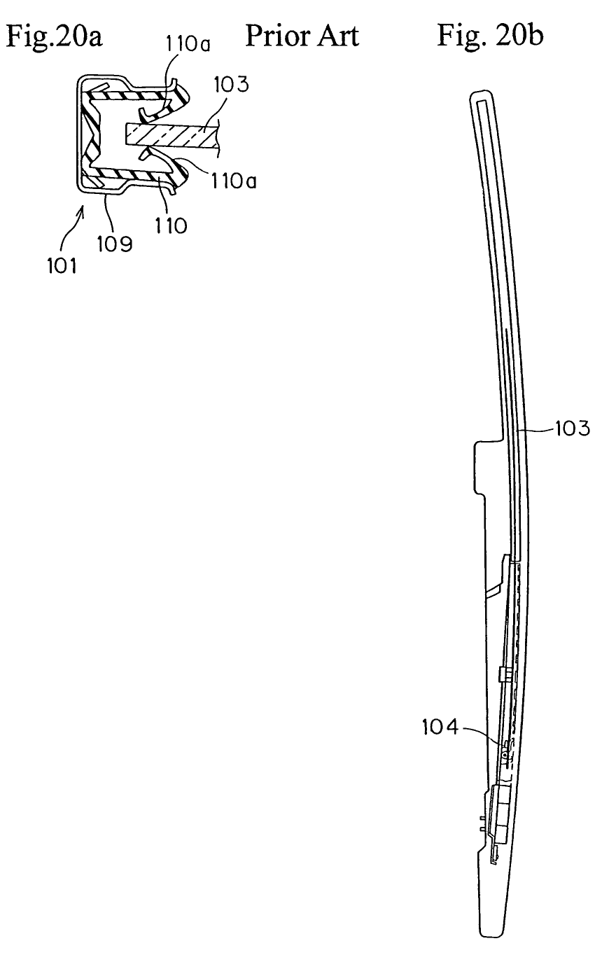

FIG. 21 is a front view showing other example of a conventional window regulator;

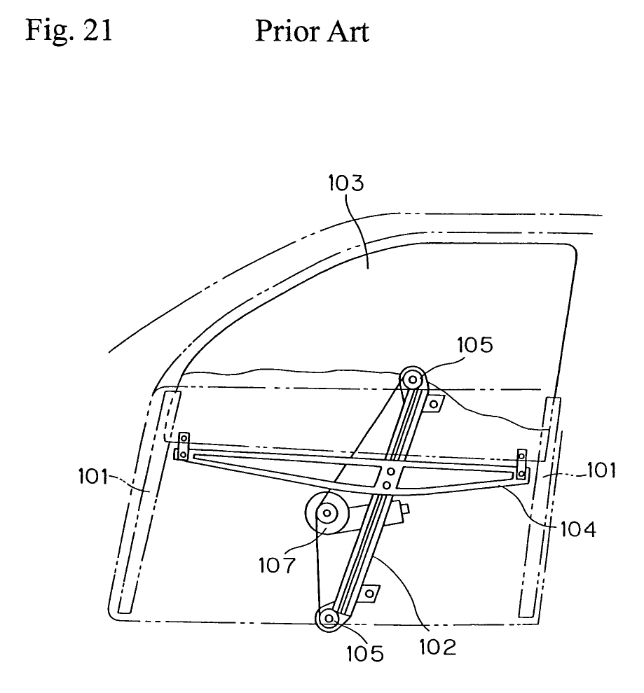

FIGS. 22a, 22b and 22c are a front view, a side view and a plan cross sectional view, respectively, showing an example for reference of a carrier plate and an area around the same in a conventional window regulator not comprising a front guide rail; and

FIG. 23 is a plan sectional view showing an example for reference in case of providing a holding structure to guide a carrier plate on a glass run guide.

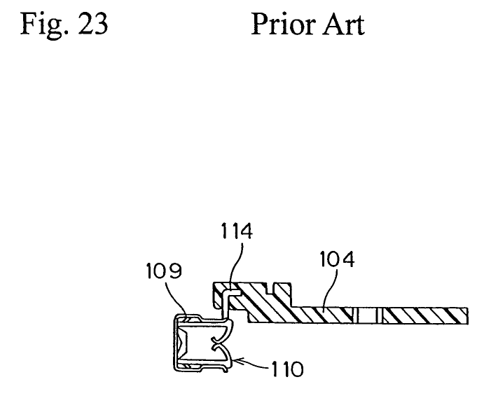

### THE PREFERRED EMBODIMENTS OF THE PRESENT INVENTION

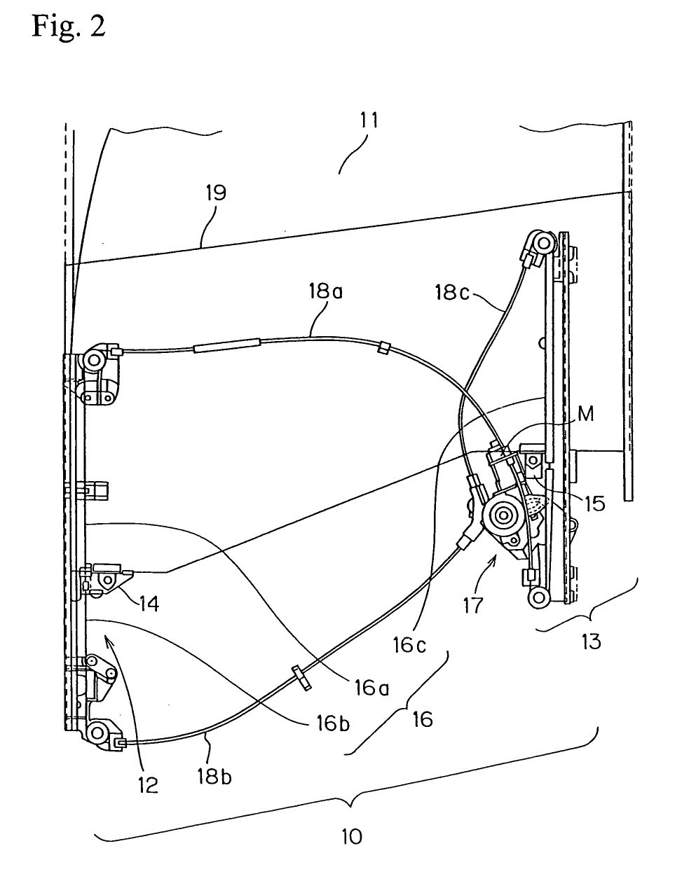

Preferred embodiments of a supporting structure and a window regulator according to the present invention is described with reference to drawings. First, the window regulator as a whole is described referring to FIG. 2. FIG. 2 shows a state as viewed from inside an automobile.

A window regulator 10 comprises a front guide structure 12 to guide ascending and descending of a glass 11 on the front side, a rear guide structure 13 to guide ascending and descending on the rear side, cables 16 stretched approximately in the shape of 8 so as to drive ascending and descending of carrier plates 14 and 15 attached to the lower edge of the glass 11, and a cable drive mechanism 17 to drive the cables in reciprocally circulate. Connected between the upper edge of the front guide structure 12 and the lower edge of the rear guide structure 13, between the cable drive mechanism 17 and the lower edge of the front guide structure 12, and between the cable drive mechanism 17 and the upper edge of the rear guide structure 13 are conduits 18a, 18b and 18c, respectively, for guiding the cables 16. As the cables 16, an inner cable of a pull-control cable formed by a twisted metal wire may be used. As the conduits 18, it is possible to use conduits for pull-control cable obtained by disposing a liner of synthetic resin tube to an inner surface of a helical tube of a helically wound metal wire and disposing a synthetic resin coating to an outer surface of the helical tube. Denoted at 19 in FIG. 2 is a so-called waistline indicating the lower edge of a window frame of a door.

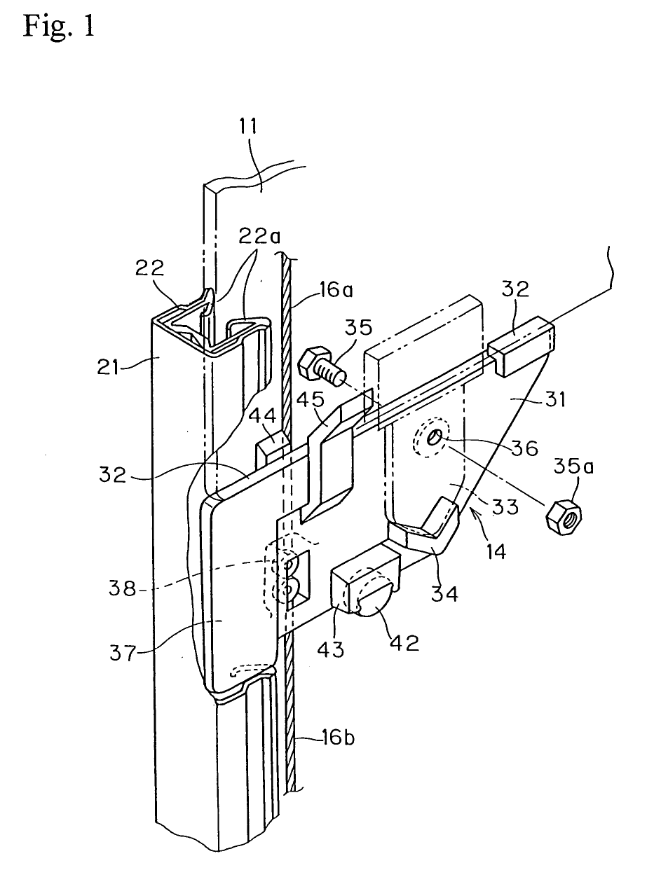

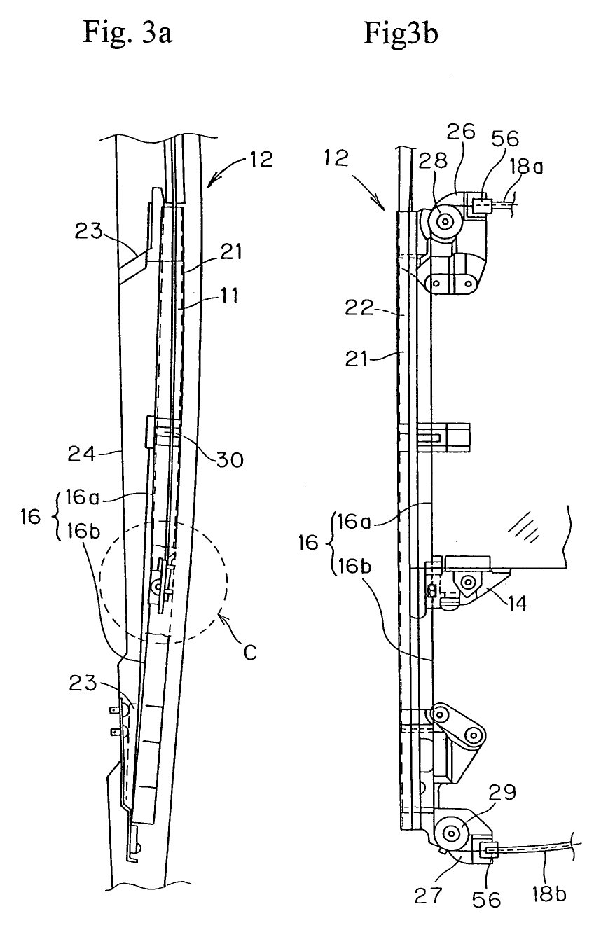

As shown in FIG. 3a, the glass 11 is curved so as to outwardly protrude. To guide the side edge of the glass 11, the front guide structure 12 comprises a front glass run guide 21 with its central portion curved so as to outwardly protrude. Inside the front glass run guide 21, a glass run 22 of rubber is housed as shown in FIG. 1. The glass run guide 21 can be manufactured by press forming of a metal sheet. The glass run 22 is made of an elastic material such as rubber, soft synthetic resin and elastomer, and can be manufactured by extrusion or the like. The glass run guide 21 is attached to a door panel 24 by upper and lower brackets 23, as shown in FIG. 3a.

As shown in FIG. 3b, pulley brackets 26 and 27 are attached to the upper edge and the lower edge of the front glass run guide 21, respectively. To these pulley brackets, pulleys 28 and 29 for changing the direction of the cables 16 are respectively attached for free rotation. The pulley brackets 26 and 27 can be manufactured by press forming of a metal sheet. As the pulleys, conventionally known molded pulleys of synthetic resin may be used. Arc-shaped slide guides to guide the cables 16 for free slide motion may be disposed instead of the pulleys 28 and 29. The pulley brackets 26 and 27 may be attached to the door panel or integrated with the door panel. An inner guide 30 for guiding the cables 16 is attached midway to the glass run guide 21. The carrier plate 14 is attached to the front lower edge of the glass 11.

The carrier plate 14, as shown in FIG. 1, comprises a board-shaped base 31, glass mounts 32 disposed respectively on the right and the left to the upper edge of the base 31, and a V-shaped supporting portion 34 supporting a support 33 fixed to the glass. In an upper part of the supporting portion 34, a hole 36 is formed for screwing the support 33 by means of a bolt 35 and a nut 35a.

The carrier plate 14 is characterized by comprising a board-shaped guide plate 37 at the left edge, allowing the glass run 22 to function as the engagement portion in claim 1 as described below. The glass plate 37 is a portion to be inserted between paired lips 22a of the glass run 22 so as to vertically slide. Since the lips 22a are flexible, the guide function of the guide plate 37 between the lips 22a provides some allowance. Hence, the glass 11 is guided by the glass run 22 and the carrier plate 14 attached to the glass 11 follows the glass 11. In other words, the guide function of the guide plate 37 by the lips 22a is weak and does not hinder the guide function of the glass run 22 for guiding the glass 11. This obviates the “skew” problem caused by the double guide.

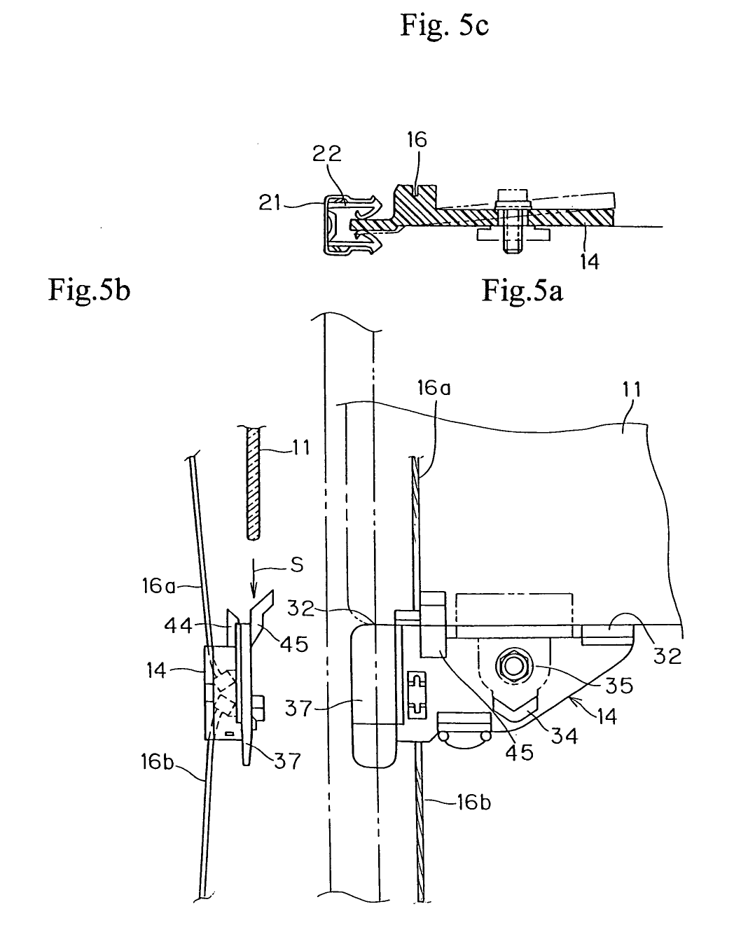

In this preferred embodiment, the guide plate 37 is rectangular and the lower portion thereof projects below beyond the base 31. The top surface of the guide plate 37 also serves as the left-side glass mount 32. The thickness of the guide plate 37 is approximately the same as that of the glass 11, but progressively thinner from the center to the lower portion of the guide plate 37 (see FIG. 5b). Further, the bottom corners on the right and the left and the outer top corners are rounded. Hence, the guide plate 37 can easily be inserted into the gal) between the lips 22a usually closed by the elastic force by insertion, from its bottom. In addition, since the guide plate becomes integrated with the glass 11 after attached and is increasingly thinner toward below, the guide plate does not prevent sliding of the glass 11 along the glass run 22. Thus, this guide plate 37 is advantageous in that it does not block ascending and descending of the glass 11 once the carrier plate 14 is attached to the glass 11, and the function and effect of the present invention is exhibited at the time of attachment of the glass 11 to the carrier plate 14 as described later.

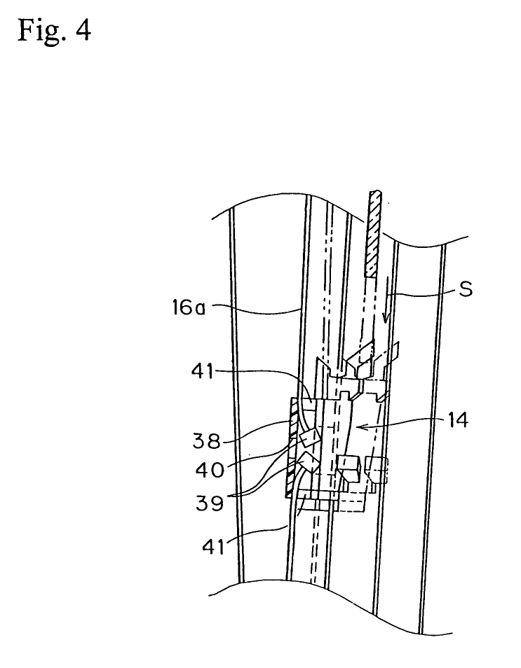

A known cable engagement portion 38 to engage end portions of the cables 16 is disposed to the back surface of the carrier plate 14 so as to protrude. The cable engagement portion 38 is a box-shaped member with its front surface open, and as shown in FIGS. 1 and 4, comprises an opening 40 to accept cable ends 39 fixed to the end portions of the two cables 16a and 16b extending above and below respectively and a slit 41 for engaging with the cable ends. Further, a cushion holding portion 43 for holding a cushion 42 of rubber or the like is formed at the front bottom edge of the carrier plate 14. In addition, paired guide pieces 44 and 45 serving as a guide for attachment of the glass 11 are disposed to the guide plate 37's side at the upper edge of the carrier plate 14. The carrier plate 14 may be made of synthetic resin such as reworked PET for instance, or alternatively, manufactured by partial insert molding of synthetic resin into a metal plate.

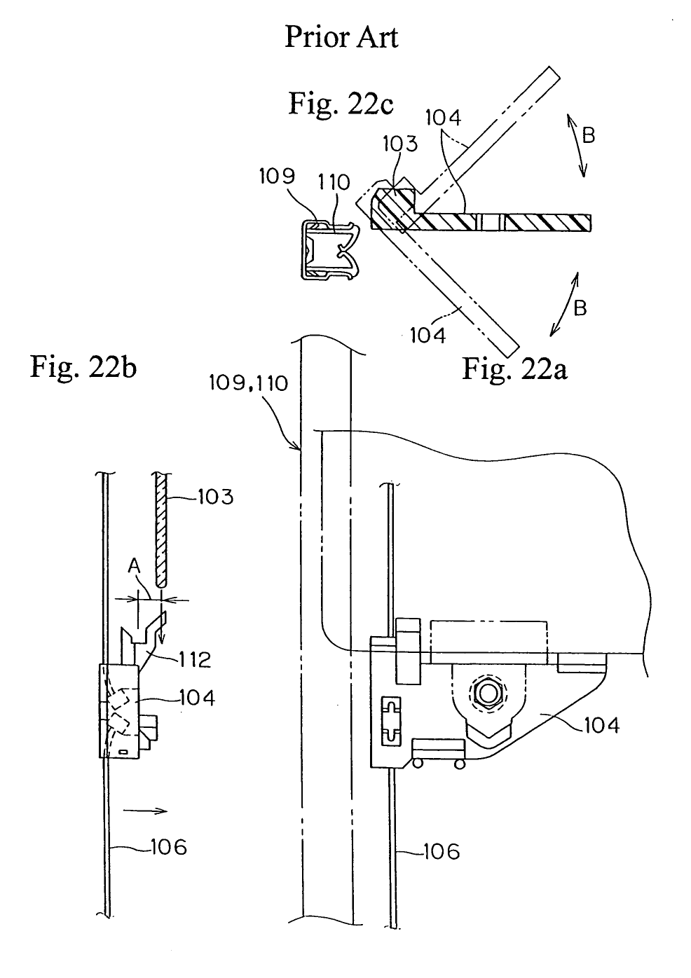

To attach the glass 11 to the carrier plate 14, first, the carrier plate 14 is fit to the end portions of the cables 16a and 16b extending above and below respectively, and the guide plate 37 is inserted between the lips 22a of the glass run 22. This brings the carrier plate 14 close to the trajectory of the glass 11, as shown in FIG. 5b. Hence, the “deviation A” from the glass 11 is small. In short, while the cables 16a and 16b extending above and below respectively are pulled straight thereby placing the guide plate far away from the trajectory of the glass if the guide plate 37 is not inserted to the glass run 22 (see FIG. 22b). If the guide plate 37 is inserted to the glass run 22, the guide plate 37 stops at quite a distance on the right-hand side against the urging force of the cables 16a and 16b as shown in FIG. 51). However, due to the tensile force of the cables 16, the right-hand side of the carrier plate 14 deviates somewhat to the left-hand side (the upper side in FIG. 5c) to the trajectory of the glass 11 as shown in FIG. 5c. Without the guide plate 37 as shown in FIG. 22c, the carrier plate 104 can freely revolve about the cable 10G supporting the carrier plate 104, while with the guide plate 37 inserted between the lips 22a as shown in FIG. 5c, the angle about the cables become approximately constant. That is, since the guide plate 37 stops at such a position that the power of the glass run 22 to hold the guide plate 37 and the tensile force of the cables 16 balance with each other, the “deviation B” in the rotative direction is small. The remaining “deviation” is absorbed by the guide pieces 44 and 45.

In other words, as the glass 11 is moved downward as denoted at the arrow S in FIG. 4, the lower edge of the glass 11 hits the slanted surfaces of the guide pieces 44 and 45, thereby inviting the carrier plate 14 toward the glass 11 as denoted at the imaginary line. Since the guide pieces 44 and 45 are close to the guide plate 37, the deviation in the rotative direction is even more smaller. Hence, as the glass 11 is merely moved to below, it is inserted between the guide pieces 44 and 45 easily and mounted on the glass mounts 32 on the carrier plate 14. Owing to this, passing the bolt 35 through the hole with one hand while holding the glass 11 with the other hand, an operator can easily attach the glass 11. In this manner, the glass run 22 can stabilize the posture of the carrier plate 14 and therefore serves as the engagement portion described in claim 1.

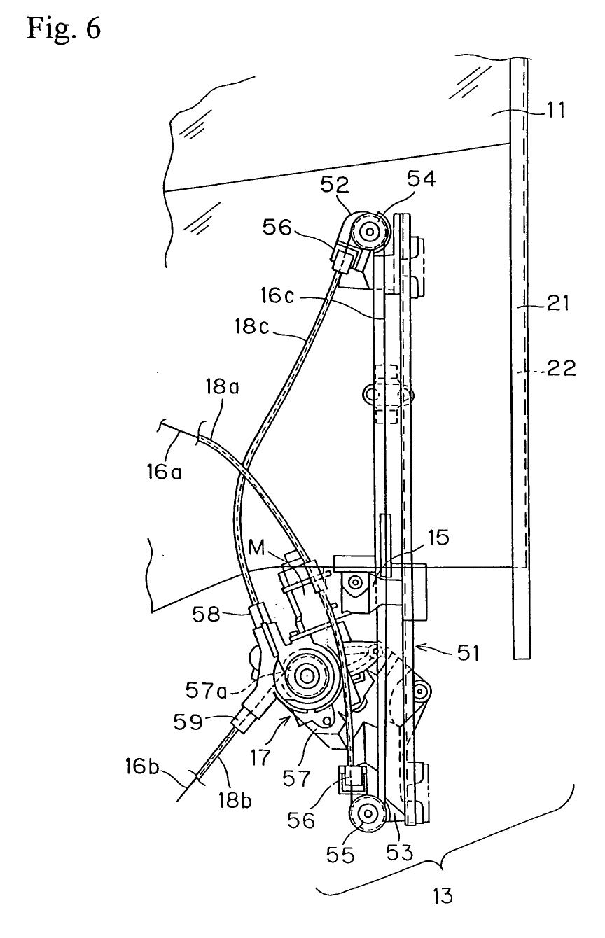

The rear guide structure 13 is described with reference to FIG. 6. The rear guide structure 13 is substantially the same as the conventional ones. That is, the rear side edge of the glass 11 is guided by the glass run guide 21 and the glass run 22 similar to those disposed to the front guide structure. A guide rail 51 for guiding a rear carrier plate 15 for free slide motion in the vertical direction is attached to a door panel in the vertical direction. Pulley brackets 52 and 53 are attached to the top and the lower edges of the guide rail 51, respectively, and pulleys 54 and 55 for changing the directions of the cables 16 are respectively attached for free rotation to these pulley brackets. The ends of the conduits 18a and 18c are attached to the pulley brackets 52 and 53 by known joints 56. The cable drive mechanism 17 is fixed to a lower portion of the guide rail 51 through a bracket 57.

The cable drive mechanism 17 is a known cable drive mechanism comprising a motor M equipped with a reducer, a drum 57a attached to the output side of the reducer, and conduit holding portions 58 and 59. The end portions of the cables 16 are engaged with the drum 57a at the cable ends and wound around the drum in opposite directions to each other. The cable 16c leaving from the cable drive mechanism 17 upwards reverses its direction downwards at the pulley 54 on the upper part of the rear guide structure 13, and further extends downwards along the guide rail 51 with the end portion of the cable engaged With the carrier plate 15. The cable is guided through the conduit 18c from the conduit holding portion 58 to the upper pulley bracket 52.

The other cable 16a with its one end engaged with the carrier plate 15 extends to below and reverses its direction at the lower pulley 55, and guided through the conduit 18a, further reverses its direction at the upper pulley 28 of the front guide structure 12 and extends downwards to be engaged with the front carrier plate 14 as shown in FIG. 3b. Midway through this, the cable is guided by the conduit 18a. The cable 16b extending downwards from the front carrier plate 14, after reversed the direction at the lower pulley 29, is guided by the conduit 18b to the cable drive mechanism 17 again. Hence, as shown in FIG. 2, the three cables 16a, 16b and 16c form a loop approximately in the shape of 8.

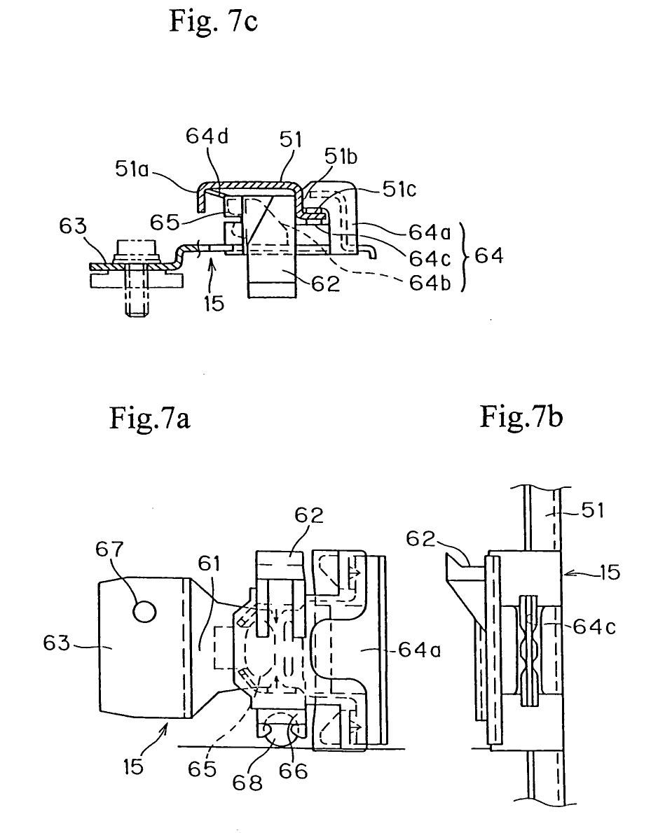

The guide rail 51 is obtained by bending a metal sheet or the like with a stamping machine, and as shown in FIG. 7c, a rib 51a arising upright is disposed to one side edge of the guide rail 51 and a guide rib 51b bent in the shape of the letter L is disposed to the other side edge of the guide rail 51. The guide rail 51 as well is curved protruding outwardly 65 fitting to the curvature of the glass 11 shown in FIG. 3a.

The rear carrier plate 15 is obtained by insert molding of synthetic resin into a press forming metal sheet, and comprises a board-shaped base 61, glass mounts 62 disposed to the upper edge of the base, a glass holding portion 63 disposed at the left edge, a guide portion 64 disposed on the right-hand side, a cable engagement portion 65 disposed on the back surface side, and a cushion holding portion 66 disposed to the lower edge, as shown in FIGS. 7a and 7c. A hole 67 to accept a bolt is formed in the glass holding portion 63. A Cushion 68 of rubber or the like is attached to the cushion holding portion 66.

The guide portion 64 comprises a first slide shoe 64a in an L shape and sliding in contact with the back surface and the outer surface of the guide rib 51b of the guide rail 51 and a second slide shoe 64b sliding in contact with the inner surface of the guide rib 51b. A guide groove 64c sliding in contact with a horizontal section 51c of the guide rib 51b is formed in the inner surface of the second slide shoe 64a. Formed in the second slide shoe 64b is a flexible tongue 64d sliding in contact with the inner corner of the guide rail 51. The cable engagement portion 65 is approximately the same as that of the front carrier plate 14 (see FIG. 4).

Since the rear carrier plate 15 moves in the vertical direction along the guide rail 51, the trajectory of the rear carrier plate 15 is the same as the curved trajectory of the glass 11. Further, the engagement of the first slide shoe 64a, the second slide shoe 64b and the like with the guide rail 51 creates almost no deviation in the direction of rotations. Hence, there is almost no “deviation” problem associated with attachment of the glass 11.

As shown in FIG. 2, in the window regulator 10 having such a structure described above, as the motor M shown rotates in one direction, one of the cables 16 is wound around the drum 57 and the other cables 16 are fed out from the drum. Thus, the loop formed by the three cables 16a to 16c circulates in one direction to move the front and the rear carrier plates 14 and 15 upwards at the same time. This moves the glass 11 upwards, thereby closing the window. At this stage, the glass 11 is guided by the front and the rear glass runs 22 and the front and the rear glass run guides 21. Meanwhile, although the rear carrier plate 15 is firmly guided by the guide rail 51, sliding between the glass 11 and the glass run 22 is not hindered since the guide rail 51 is far enough from the rear glass run guide 21. In addition, while the front carrier plate 14 is inserted into the front glass run 22 as described earlier, some allowance provided does not prohibit the sliding between the glass 11 and the glass run 22.

As described above, in the window regulator 10 according to this preferred embodiment, despite omission of a guide rail guiding the front carrier plate 14, there is less deviation between the carrier plate 14 and the glass 11 before attachment of the glass 11 to the carrier plate 14, owing to the supporting mechanism for the carrier plate 14 using the guide plate 37 to be inserted in the front glass run 22. This realizes easy attachment of the glass 11. Further, the guide plate 37 hardly influences over normal ascending and descending.

While the preferred embodiment above omits a guide rail for the front guide structure, a guide rail for the rear guide structure may be omitted. In that case, a guide plate is preferably disposed to the rear carrier plate 15 as well as for the front carrier plate. In addition, although it is easy to maintain the integrity of the window regulator if one of the front or the rear guide rails is left, both the front and the rear guide rails may be omitted in some cases. While the cables are guided through the flexible conduits in the preferred embodiment, rigid pipes may be used for guiding. Also, the conduits may be omitted if a cable runs across pulleys with tension. Although the loop of the cables circulates driven by the motor in the window regulator described above, the cable loop may be driven with a manually operated crank handle.

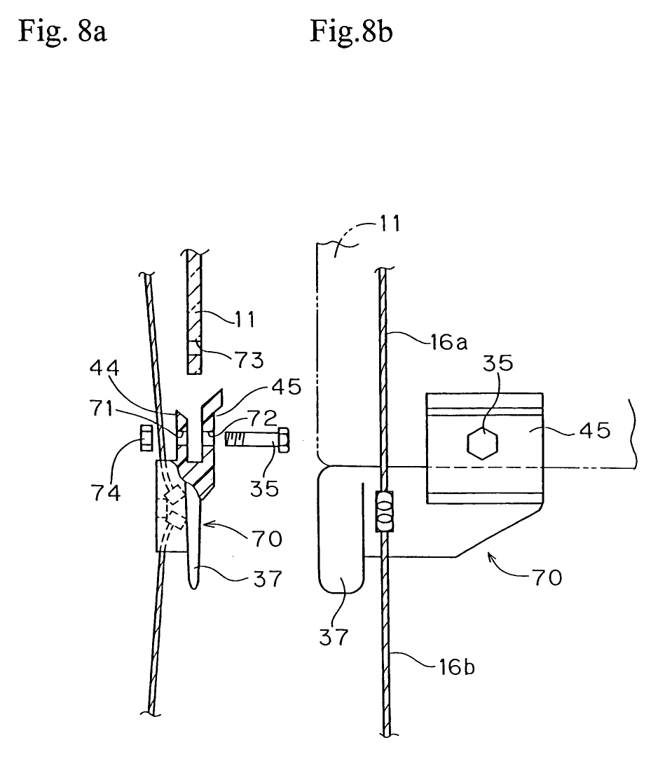

In a carrier plate 70 shown in FIGS. 8a and 8b, the guide pieces 44 and 45 receiving the lower edge of the glass 11 are disposed corresponding to each other on the front and the rear respectively, and the lower edge of the glass 11 is inserted into a groove between these. Holes 71 and 72 are formed to be concentric with the guide pieces 44 and 45 respectively, and the bolt 35 is passed through the holes 71 and 72 and a hole 73 formed in the vicinity of the lower edge of the glass 11 and fixed with a nut 74 or the like. While the glass 11 can be more easily positioned in general if a support 36 is attached in advance to the glass 11 as shown in FIG. 1, such method as that the guide plate 37 stabilizes the posture of the carrier plate 70 can be used for the benefit of reducing a number of components used.

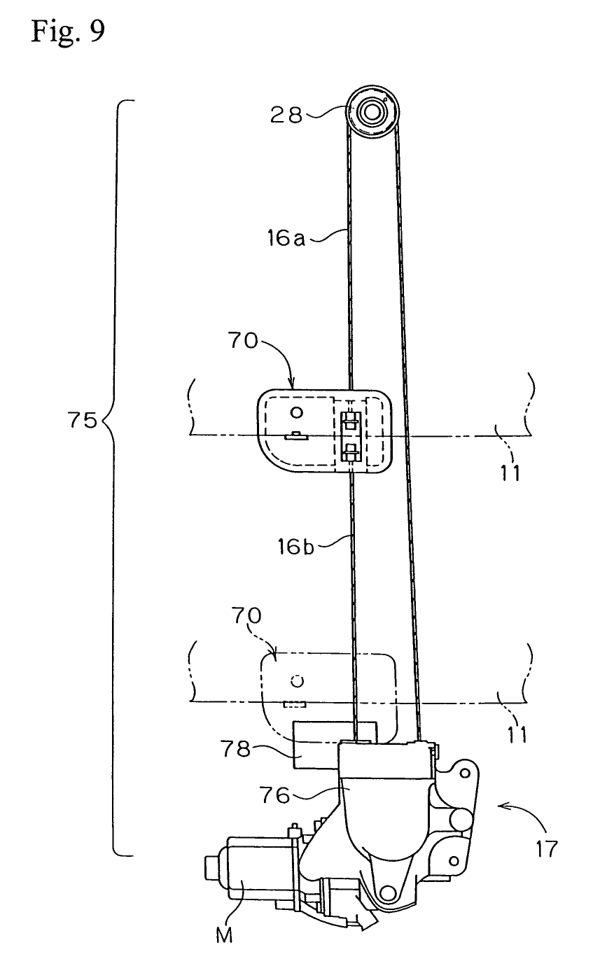

A window regulator 75 shown in FIG. 9 is of a type to be attached directly to a door panel or the like, and therefore, does not use a guide rail. In this type of window regulators, the pulley 28 is disposed for free rotation in an upper portion, the cable drive mechanism 17 is disposed in a lower portion, and between them, the cables 16a and 16b are stretched with tension in the shape of a closed loop. The cable end of the cable 16a for ascending and the cable end of the cable 16b for descending are engaged with the carrier plate 70. The carrier plate 70 is attached directly to the lower edge of the glass 11. The pulley 28 and the cable drive mechanism 17 are each attached to a door panel or the like. After assembled, the glass runs guide the glass 11 at the right and the left edges of the glass, and therefore, the carrier plate 70 follows the glass 11. For this reason, any guide is not provided for the carrier plate 70. Further, since the cable drive mechanism 17 is disposed in the lower portion, there is no need to dispose a pulley on the lower edge side. Thus, the structure is simple.

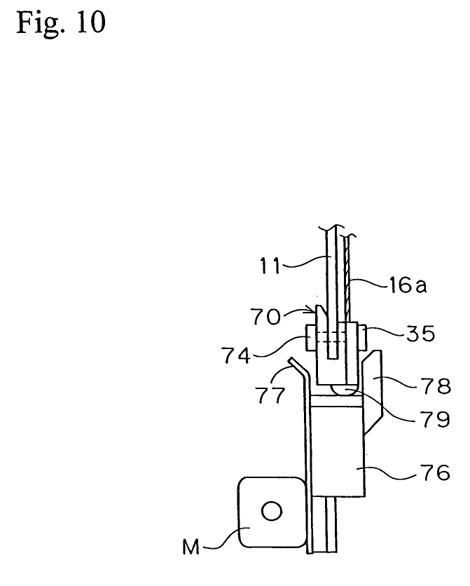

The window regulator 75 is characterized by that engagement pieces 77 and 78 engaging with a lower edge portion of the carrier plate 70 are disposed to a housing 76 to house the drum of the cable drive mechanism 17 as shown in FIG. 10. The engagement pieces correspond to the engagement portions described in claims 1 and 5. In addition, they are arranged below the range of normal ascending and descending strokes of the carrier plate 70 associated with opening and closing of the glass 11. In this preferred embodiment, the upper edge of the engagement piece 77 is somewhat open outwardly to easily receive the carrier plate 70. The carrier plate 70 is integrated with the glass 11 as in FIG. 7, and comprises at its lower edge a cushion 79 of rubber or the like. The cushion 79 may be disposed to the side of the carrier plate 70.

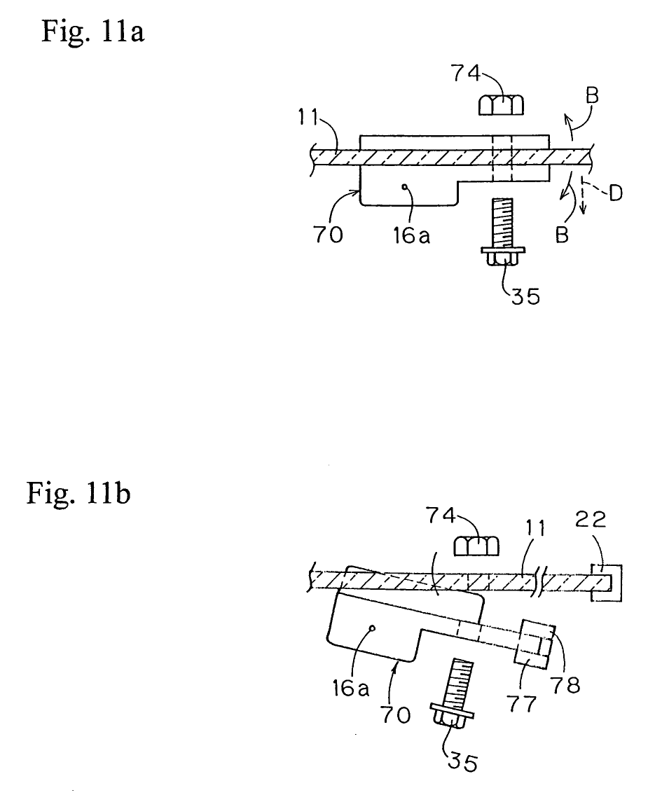

The function of the supporting structure as that described above is now described. When positioned on the upper side in FIG. 9 (e.g., the position denoted at the solid line), the carrier plate 70 is merely hung by the cables 16a and 16b and therefore remains capable of freely revolving about the cables 16a and 16b as denoted at arrows B in FIG. 11a. At the same time, the carrier plate 70 is pulled by the tension force of the cables in the direction of an arrow D. Hence, it is complicated to attach the glass 11 guided by the glass run to the carrier plate 70. Noting this, the carrier plate 70 is moved to the bottom end and the lower edge of the carrier plate 70 is fit between the engagement pieces 77 and 78 of the housing 76 as denoted at the imaginary line in FIG. 9 or as shown in FIG. 10, so that the posture of the carrier plate 70 becomes stable. This makes it easy to attach the glass 11 to the carrier plate 70.

After the attachment, the cables 16a and 16b are driven to slightly move the carrier plate 70 upward to avoid interference with the engagement pieces 77 and 78. When normally ascending and descending, the carrier plate 70 does not interfere with the engagement pieces 77 and 78 since it does not descend down to the positions of the engagement pieces 77 and 78.

The engagement pieces (tentative receivers) may be disposed at such height midway through strokes of normal ascending and descending, instead of at the bottom end of the ascending and descending strokes of the carrier plate 70. In this case, as shown in FIG. 11b, a tentative receiver 78a is disposed at the position not to cause interference with ascending and descending of the carrier plate 70. This tentative receiver 78a can be fixed to an inner panel or so on. Engagement pieces 77 and 78 are disposed on the front and the rear of the tentative receiver 78a respectively. At the time of shipment, the carrier plate is fixed to the engagement pieces 77 and 78. For assembling, the glass 11 is moved downward along the glass run 22 or a sash, seated on the glass mounts 32 of the carrier plate 70, adjusted in height, and fastened while bringing the carrier plate 70 closer to the glass 11 with the bolt 35 or the like.

In this case, it is preferable that the glass mounts 32 to receive the lower edge of the glass 11 are wide from the front to the rear to a certain extent and flat so that the carrier plate 70 can easily move in the horizontal direction or around the cable 16a. In addition, the tentative receiver 78a is preferably disposed at the one end (the right-hand side in FIG. 11b) of the carrier plate 70 opposed to its other end engaged with the cable 16a, so as to be easily mounted and detached by means of rotations of the carrier plate 70 around the cable 16a. Alternatively, as in the case of the guide piece 45 shown in FIG. 1, a tapering portion with an enough length from the front to the rear may be formed. Further, among the engagement pieces 77 and 78, the engagement piece 78 closer to the glass 11 may be omitted for easy traversing in the direction of the arrow F with the glass 11 mounted on the glass mounts 32, or it is desirable that the engagement piece 78 is formed as a shallow step.

As denoted at imaginary line in FIG. 11b, once the carrier plate 70 is attached to the glass 11, the carrier plate 70 moves along the glass runs, and therefore, the carrier plate 70 is guided by the glass runs 22 fixed with glass 11. Accordingly, during normal ascending and descending, carrier plate 70 does not interfere with the engagement pieces 77 and 78.

The cable drive mechanism 17 is disposed at the bottom end in the window regulator 75 described above, and hence, it is possible to wind up the downward cables directly to the drum or feed out the cables. This therefore demands fewer components and allows easier assembling as compared to where the directions of cables are reversed by means of a lower pulley (see the guide structure on the right-hand side in FIG. 2 or 6), a slide guide member to guide the cables for slide motion. If modified so as to support the glass 11 at the center of the glass, the window regulator 75 alone can move the glass 11 upward and downward. Alternatively, this may be used as a rear-side guide structure for a window regulator comprising the guide structures 12 and 13 on the front and the rear respectively as shown in FIG. 2. In such case, the cables are stretched in the shape of 8.

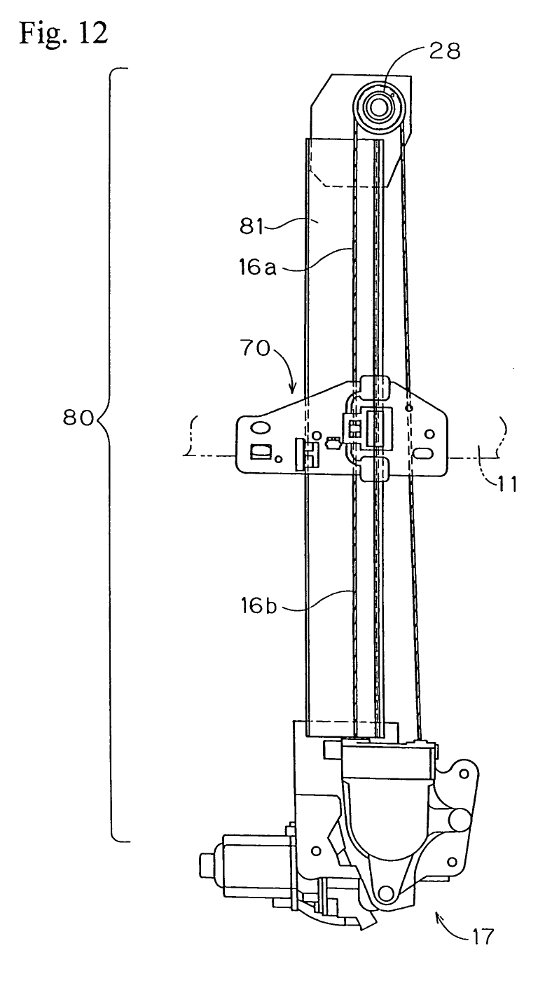

A window regulator 80 shown in FIG. 12 is basically the same as the window regulator 75 shown in FIG. 9, except that the window regulator 80 comprises a guide rail 81 to guide vertical sliding of the carrier plate 70. The guide rail 81 is curved so as to outwardly protrude, and it corresponds to the trajectory of the glass. Since the carrier plate 70 is guided by the guide rail 81 even before the glass 11 is attached, the carrier plate always remains at positions on the trajectories of the ascending or descending glass. This eliminates the necessity of disposing an engagement piece to the housing 76 to house the drum of the cable drive mechanism 17. Since the cable drive mechanism 17 is disposed at the bottom end, as in the window regulator 75 shown in FIG. 9, a lower pulley and a slide guide member are not necessary and the structure is therefore simple. Moreover, this may be used as a rear-side guide structure for a window regulator comprising guide structures on the front and the rear respectively and 16r cables stretched in the shape of 8. Further, for uses as a single window regulator or as a front and a rear guide structures, the guide rail 81 may be integrated with a door panel and an upper pulley and the cable drive mechanism 17 at the bottom end may be then attached to the door panel, to thereby fabricate the window regulator.

Although the engagement pieces 77 and 78 are disposed to the housing 76 housing the drum of the cable drive mechanism 17 in this preferred embodiment, when a pulley for changing the directions of cables or a slide guide member is to be disposed at the bottom end, the engagement pieces can be formed in other members such as pulley brackets.

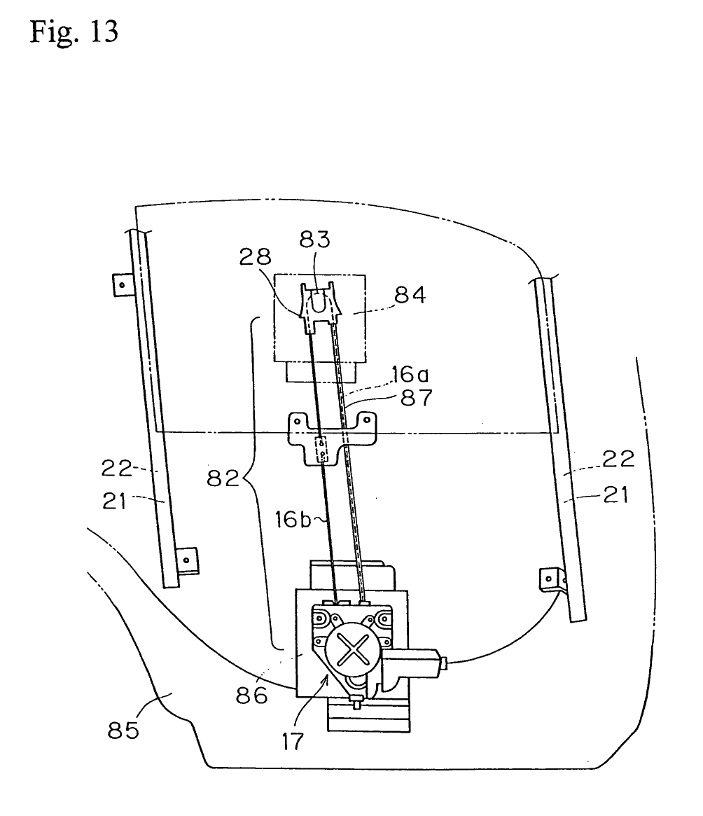

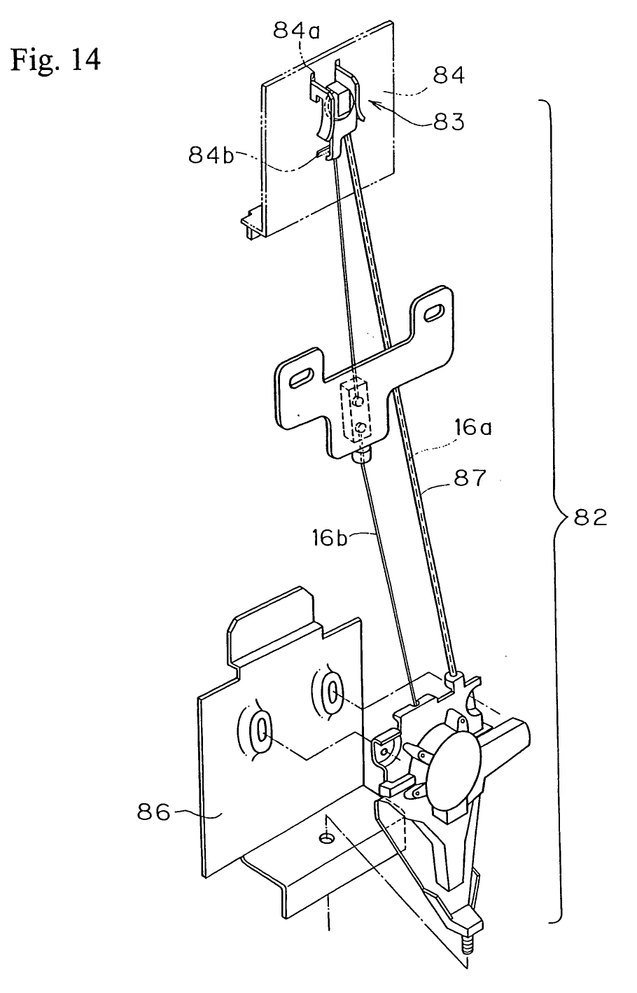

A window regulator 82 shown in FIGS. 13 and 14 is substantially the same as the window regulator 75 shown in FIG. 9, except that the upper pulley 28 is attached to an inner panel 85 through a supporting bracket (pulley bracket) 83 and a mounting bracket 84, the cable drive mechanism 17 is attached to the inner panel 85 through a mounting bracket 86 and there is a tube 87 internally carrying a return cable (of the side without the carrier plate) disposed between the supporting bracket 83 and the cable drive mechanism 17.

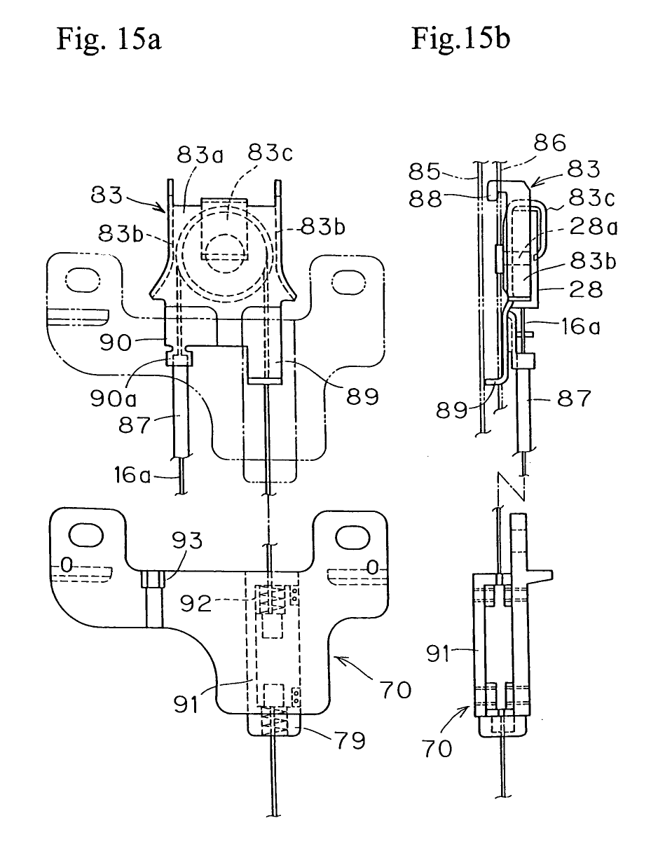

As shown in FIG. 15b, the pulley 28 is attached to the supporting bracket 83 so as to freely rotate about an axis 28a, and the supporting bracket 83 is engaged with the mounting bracket 86 by engagement tabs 88 disposed on the left and the right respectively and an engagement piece 89 disposed in a lower portion. The mounting bracket 86 is fixed by spot welding or the like to the inner panel 85 disposed inside a door of an automobile. The mounting bracket 86 is obtainable by bending a metal sheet.

In this preferred embodiment, as shown in FIG. 15a, the supporting bracket 83 is obtained by press forming of a metal sheet and includes a flat section 83a at the center, side pieces 83b disposed on the left and the right respectively arising toward the front side (the right-hand side in FIG. 15b) at the left and right ends of the flat section, a supporting piece 83c arising toward the front side from the center at the top) of the flat section 83a and then bending to below, and an engagement piece 89 and a supporting piece 90 extending toward below from the left and right bottom ends, respectively, of the flat section 83a. A hole for accepting the axis 28a is formed at the center of the flat section 83a, and an end portion of the axis 28a accepted by the hole is supported by a bent tip portion of the supporting piece 83c so as not to escape.

The top ends of the side pieces 83b on the left and the right respectively are the engagement tabs 88, described above, protruding toward the rear side. The other portions of the side pieces 83b surround the pulley 28 to protect it while serving to prevent the cable 16a engaged with an engagement groove around the pulley 28 from escaping. The right and left engagement tabs 88 are engaged with a slit (denoted at 84a in FIG. 14) formed in the mounting bracket 84. The bottom ends and neighboring areas of the right and left side pieces 83b expand while curved so as not to interfere with the cable 16a. The cable 16a engaged with the pulley 28 slightly extends with a distance to below.

The engagement piece 89 extending toward below is deviated to one side as shown in FIG. 15a (the right-hand side in FIG. 15a as viewed from the back). In addition, as shown in FIG. 15b, it projects in some degree from the flat section 83a thereby creating a step on the rear side, the bottom end is bent further toward the rear to be fit with an intrusion slit (denoted at 84b in FIG. 14) formed in the mounting bracket 84.

The supporting piece 90 is disposed on the opposite side to the engagement piece 89 at the lower edge of the flat section 83a and protrudes from the flat section 83a to thereby create a step on the front side. A cylindrical holding portion 90a for fixing the top end of the tube 87 is disposed to the bottom end of the holding piece 90. The top end of the tube 87 is pressed into the holding portion 90a, whereby the top end of the tube 87 is held. The tube 87 is of synthetic resin such as polypropylene for example. While letting the returning section of the ascend cable 16a pass, the tube 87 functions as an engagement portion for stabilizing the posture of the carrier plate during attachment of the glass 11 to the carrier plate 70 as described later, but not for supporting the reactive force of the cables like a conduit for control cable.

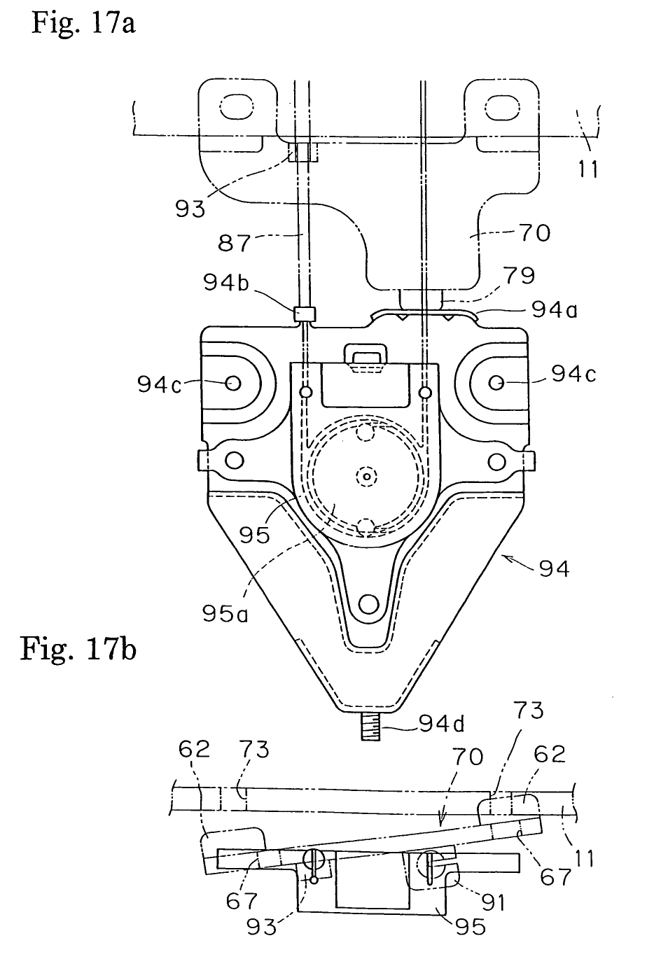

In the carrier plate 70 shown in FIGS. 15a and 15b, a cable engagement portion 91 comprised of a molded member of synthetic resin for instance is disposed so as to protrude, engaging with each ligament clamp for the ascend cable 16a and the descend cable 16b on its back surface. In this preferred embodiment, a stretching remover mechanism 92, absorbing initial cable loosening and aging-induced stretching caused during use over a long period of time, is incorporated in the cable engagement portion 91. The stretching remover mechanism 92 may be 16 comprised of a spring or the like for urging the ligament clamps along the extending direction of the cables. Further, the back surface of the carrier plate 70 provide with a fit projection 93 freely fitting with and separating from the tube 87 at the bottom end of the ascending and descending strokes as shown in FIG. 17a.

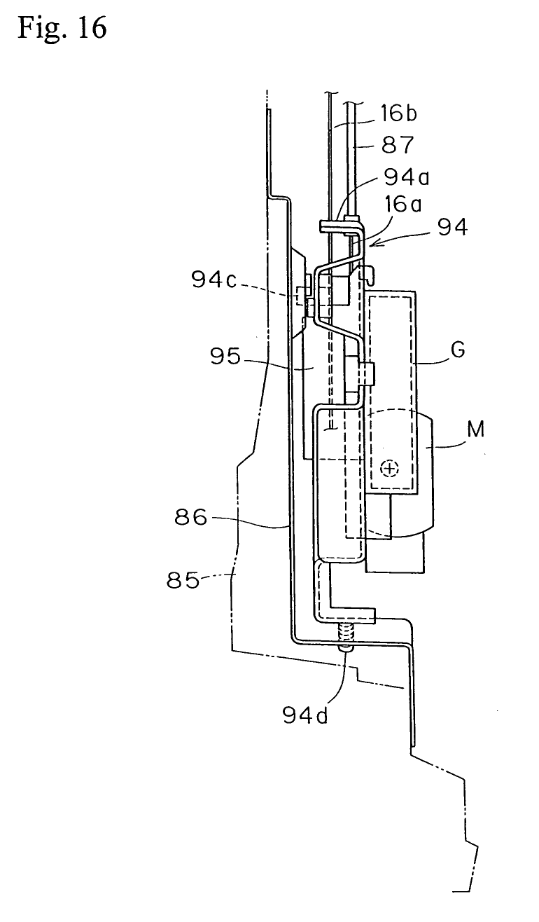

The cable drive mechanism 17, as shown in FIG. 16, comprises a motor bracket 94, a drum housing 95 disposed to the back surface thereof, a motor M and a reducer G disposed to the front surface thereof. The drum housing 95 and a housing for the reducer G are screwed from the front and the rear with the motor bracket 94 between the two, to be fixed to the motor bracket 94. This demands only a small space and realizes easy maintenance of the motor.

As shown in FIG. 17, a drum 95a for winding up the cables and feeding out the cables is housed for free rotations within the drum housing 95. The drum 95a is fixed to an output axis of the reducer G. The motor bracket 94 can be manufactured by press forming of a metal sheet, and in this preferred embodiment, comprises at its top end a stopper 94a to abut on the cushion 79 of the carrier plate 70 and a holding portion 94b to hold the bottom end of the tube 87. Further, as shown in FIGS. 16 and 17, two upper screws 94c for attachment to the mounting bracket 86 and one lower screw 94d extending to below are fixed to the motor bracket 94. As the motor bracket 94 comprises projections protruding toward the rear for seats for these screws and an approximately cross-shaped flat section for fixing the drum housing 95 and the housing for the reducer, and the shape of the motor bracket 94 provides improved strength.

The mounting bracket 86 for the cable drive mechanism 17, as shown in FIG. 16, has a bent shape in accordance with the bumps of the inner panel 85. Hence, it is easy to attach the cable drive mechanism 17 to the inner panel 85.

As for the window regulator 83 having such a structure as that described above, for attachment of the carrier plate 70 to the glass 11, first, as shown in FIG. 17a, the carrier plate 70 is moved to the bottom end of the ascending and descending strokes. Next, as shown in FIG. 171), the fit projection 93 of the carrier plate 70 is fit with the outer periphery of the tube 87 while tilting the right-hand side of FIG. 17b forward. In this condition, the carrier plate 70 is prevented from revolving around the cables 16 or swaying back and forth. In this state, the glass is inserted into the glass run (denoted at 22 in FIG. 13), moved to below, and mounted on one of the glass mounts 62 (on the right-hand side in FIG. 17b) of the carrier plate 70. One bolt or screw is passed through the hole 67 of the carrier plate 70 and fit to the hole 73 of the glass 11 for tentative fixing in this condition to thereby support the weight of the glass. The fit projection 93 is then detached from the tube 87, the glass 11 is mounted on the both glass mounts 62, and the holes 67 and the holes 73 of the glass are aligned to each other and fixed, respectively. In such a window regulator 83 as well, it is easy to attach the carrier plate 70 to the glass 11.

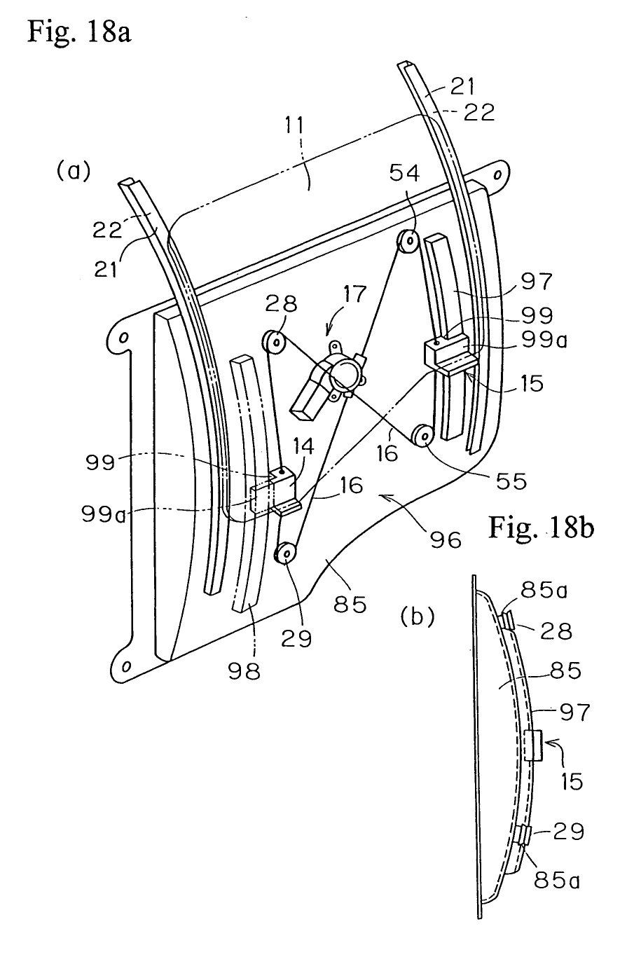

A window regulator 96 shown in FIG. 18a is of a type to be attached directly to the inner panel 85 disposed inside a door of an automobile, and therefore, a guide rail is not used. The window regulator 96 comprises the inner panel 85, the pulleys 28 and 29 respectively attached for free rotations above and below on the left-hand side of the inner panel, the pulleys 54 and 55 respectively attached for free rotations above and below on the right-hand side, the cables 16 wound around these pulleys in the shape of 8, the front carrier plate 14 and the rear carrier plate 15 disposed in engagement on the cables, and the cable drive mechanism 17 driving the cables into rotations.

The window regulator 96 does not comprise a guide rail as that described earlier (51 in FIG. 6), and therefore, the four pulleys 28, 29, 54 and 55 are all attached for free rotations to a projection 85a disposed to the inner panel 85 as shown in FIG. 18b. The projection 85a may be formed as an integral portion of the inner panel 85, or alternatively, fixed by welding or the like to the inner panel 85. The cable drive mechanism 17 is fixed to the center of the inner panel 85.

Further, in this preferred embodiment, a guide projection 97 is formed as an integral portion of the inner panel 85 so as to be approximately parallel to the rear glass run 22. The guide projection 97 is curved along with the trajectory of the glass 11. Hence, as the rear carrier plate 15 is pulled by the cables 16 toward the inner panel 85, the back surface of the rear carrier plate 15 comes into contact with the surface of the guide projection 97. Thus, the rear carrier plate 15 stays supported by the guide projection 97 even when not yet attached to the glass 11, and its posture becomes stable as brought to the position about same as the ascending trajectory after attachment to the glass 11. Thus, the carrier plate 15 attached to the cables 16 in advance gains a stable position and posture, thereby making it easy to attach the carrier plate 15 to the glass 11 guided by the glass run 22. Further, since the window regulator 96 does not use a guide rail, the doors of an automobile are light in weight and the number of assembly steps decreases.

Although the preferred embodiment shown in FIG. 18a uses the guide projection 97 sliding in contact with the rear carrier plate 15, a guide projection sliding in contact with the front carrier plate 14 may be disposed as denoted at the imaginary line 98. A guide projection may be disposed only to the front carrier plate, or guide projections may be disposed to both the front and rear carrier plates. In either case, the guide projections 97 and 98 may be obtained by drawing or the like at the same time with press forming of the inner panel 85. Since the guide projections 97 and 98 exhibit the function as vertical ribs for the inner panel 85, there is an advantage of that the strength or rigidity of the inner panel 85 improves. While the inner panel 85 is normally made of a metal sheet such as a thin copper sheet, synthetic resin can be used for this purpose.

It is preferable that the inner panel 85 in other portions than at the guide projections 97 and 98 also projects to be curved along the trajectory of the glass 11 as shown in FIG. 18b. This ensures large space S for housing interior equipment, such as a speaker, of the doors of an automobile. The inner panel herein referred to also includes a base plate capable of attachment to an opening of the regular inner panel 85 and the like.

In addition, a projection or step portion 99 sliding in contact with the side surface of the guide projection 97 may be disposed to the back surface of the carrier plate 15 in this preferred embodiment. Denoted at 99a is a slide piece sliding in contact with the surface of the guide projection 97. Where such a step portion 99 is disposed, as in the case of conventional guide rails, it is possible to restrain a deviation of the glass 11 in the direction of anteversion, and hence, it is possible to obtain further stable guide function. Where the front guide projection 98 and the slide piece 99a are disposed, a similar projection or step portion 99 and a similar slide piece 99a can be disposed to the front carrier plate. In this case, the step portions 99 of the front and the rear carrier plates 14 and 15 realize the guide function for the glass 11.

In these preferred embodiments, pulleys were arranged for changing the direction of the cables, slide guide who abuts with the cable could be used for this purpose.

What is claimed is:

1. A curved glass support structure, comprising:
a carrier plate attached to a curved glass elastically guided at a side edge by a glass run;
a cable stretched in parallel to the glass run and engaged with the carrier plate; and
an engagement portion engaging the carrier plate during attachment of the glass to the carrier plate to thereby stabilize the posture of the carrier plate.

2. A curved glass support structure in accordance with claim 1, wherein a guide plate sliding inside the glass run is disposed to the carrier plate, and the glass run serves as the engagement portion.

3. A curved glass support structure in accordance with claim 2, wherein the guide plate has substantially the same thickness as that of the glass.

4. A curved glass support structure in accordance with claim 1, 2 or 3 wherein the guide plate is formed of synthetic resin.

5. A curved glass support structure in accordance with claim 1, wherein the engagement portion engages with the carrier plate when the carrier plate is not fixed to the glass, while the engagement portion is located at Such a position not to cause interference with the carrier plate when the carrier plate is fixed to the glass in an ascending and descending operation.

6. A window regulator for curved glass, comprising:
a first carrier plate and a second carrier plate attached to the lower edge of a curved glass elastically guided at the both side edges by glass runs;
a cable engaged with the both carrier plates and stretched in parallel to the glass runs disposed on the front and the rear respectively;
a cable drive mechanism for driving the cable to thereby drive the glass through the carrier plates; and
an engagement portions engaging with the carrier plates during attachment of the first carrier plate and/or the second carrier plate to the glass to thereby stabilize the postures of the carrier plates.

7. A window regulator in accordance with claim 6, wherein the first carrier plate or the second carrier plate is attached to an end and neighboring portion at the lower edge of the glass, guide plates sliding inside the glass runs are disposed to the carrier plates, and the glass runs are the engagement portions.

8. A window regulator in accordance with claim 6, wherein guide projections extending in parallel to the glass runs are formed in an inner panels as integrated portions that the guide projections slide in con tact with the carrier plates to thereby stabilize the postures of the carrier plates, and the guide projections are the engagement portions.

9. A window regulator for curved glass, comprising:
a carrier plate attached to the lower edge of a curved glass elastically guided at the both side edges by glass runs;
a cable engaged with the carrier plate and stretched in parallel to the glass runs disposed on the front and the rear respectively;
a guide member attached to a panel, for the purpose of changing the direction of the cable;
a cable drive mechanism attached to a panel for driving the cable to thereby drive the glass through the carrier plate; and
an engagement portion engaging with the carrier plate during attachment of the carrier plate to the glass to thereby stabilize the posture of the carrier plate.

10. A window regulator in accordance with claim 9, wherein the engagement portion is disposed to the upper edge of the cable drive mechanism.

11. A window regulator in accordance with claim 9, wherein the engagement portion is a tube surrounding the cable on the returning side, disposed between the guide member and the cable drive mechanism, and a fitting portion fit around the tube to be freely attached and detached is disposed to the carrier plate.
